(19) United States
(12) Patent Application Publication
(10) Pub. No.: US 2021/0303711 A1
(43) Pub. Date: Sep. 30, 2021

(54) SYSTEM AND METHODS FOR SECURELY STORING AND SHARING DIGITAL ARTIFACTS

(71) Applicant: Spenego Software, LLC, Downingtown, PA (US)

(72) Inventors: Michael J. MORGAN, Downingtown, PA (US); Muhammad A. MUQUIT, Exton, PA (US)

(73) Assignee: Spenego Software, LLC, Downingtown, PA (US)

(21) Appl. No.: 16/828,539

(22) Filed: Mar. 24, 2020

(51) Int. Cl. G06F 21/62; H04L 29/06; G06F 3/0481

(52) U.S. Cl. CPC G06F 21/6209; G06F 3/0481; H04L 63/108

(57) ABSTRACT

The secure digital storage and sharing system for a plurality of users, each user associated with a computing device, having at least one item configured to store information and selectively switch between a private and a shareable status, at least one container configured to hold the at least one item and selectively switch between a private and a shareable status, an encryption module, and a software application. The private status is configured to prevent the at least one item and the at least one container from being shared with and accessed by users. The shareable status is configured to allow the at least one item and the at least one container to be shared with and accessed by users. The shareable status of the at least one item and the at least one container is selectively revocable. The shareable status may also expire after a selected time period.

### TECHNICAL FIELD

The present disclosure relates generally to systems and methods for digital storage and sharing, and in particular to secure storage and sharing of digital artifacts and information.

### BACKGROUND

Computing devices and systems are used for a wide variety of information exchange purposes. Users may utilize computing devices to create, access, and share confidential digital artifacts (for example personal notes, contact information, login credentials, bank accounts, safe combinations, etc.). Existing technologies including password managers share a common or master password to access the collection of artifacts. Another common technique is storing the confidential digital artifacts in a shared spreadsheet with password protection. These methods, however, expose all private information to every party that has knowledge of the common password. Therefore, there is no granularity in fine-grained control over what artifacts should be exposed to whom. Changing the common or master password under these methods requires the common or master password to be sent out-of-band to all users sharing the spreadsheet; possibly via insecure channels. Additionally, if a malicious third party gains knowledge of the common password, that party will have exposure to all artifacts.

Other traditional approaches of digital artifacts sharing include out of band mechanisms such as email, short message service, phone calls, etc. These methods, however, are neither secure nor scalable. In addition, most of the identified techniques allow for forwarding to a third party. These methods lack auditing and accountability of user actions. A common problem for these traditional methods is that they do not support a method to revoke once the sharing is done.

### SUMMARY

There is a need for a system to securely store and selectively and securely share certain artifacts or information to targeted users. An embodiment of the present disclosure is a digital storage system for a plurality of users, each user associated with a computing device. The digital storage system includes at least one item including information, the at least one item configured to be selectively switchable between a private status and a shareable status. The digital storage system further includes at least one container to hold the items and configured to be selectively switchable between a private status and a shareable status. The shareable status of the at least one item and the at least one container is selectively revocable. The digital storage system further includes an encryption module configured to encrypt the at least one item. The digital storage system further includes a software application, configured to, when executed by a computer processor, encrypts the at least one item. The software application is further configured to determine whether each one of the at least one item and the at least one container is private or shareable. The software application is further configured to, if the at least one item and the at least one container is shareable, share the item or share the item and the container with one or more users. The software application is further configured to selectively revoke shareability of the item or shareability of the container and the item in it.

Another embodiment of the present disclosure is a method for securely sharing information. The method includes inputting with a user interface information into an item stored in computer memory of a computing device, wherein an item is held in a container. The method further includes encrypting the item. The method further includes determining whether each one of the items and the container is private or shareable. The method further includes if the item and the container is shareable, sharing the item or sharing the item and the container with one or more users. The method further includes selectively revoking shareability of the item or selectively revoking the shareability of the container and the item in it.

### BRIEF DESCRIPTION OF THE DRAWINGS

The foregoing summary, as well as the following detailed description, will be better understood when read in conjunction with the appended drawings. The drawings show illustrative embodiments of the disclosure. It should be understood, however, that the application is not limited to the precise arrangements and instrumentalities shown.

FIG. 1 is a schematic diagram of a system according to an embodiment of the present disclosure;

FIG. 2 is a schematic diagram of an item of the system shown in FIG. 1;

FIG. 3A is a schematic diagram of an exemplary container of the system shown in FIG. 1;

FIG. 3B is a schematic diagram of an exemplary container of the system shown in FIG. 1;

FIG. 4 is a diagram illustrating multiple, networked computing devices, according to an embodiment of the present disclosure;

FIG. 5 is a server computing device shown in FIG. 4;

FIG. 6 is a process flow diagram illustrating a method for creating an item;

FIG. 7 is a process flow diagram illustrating a method for creating a private or a shareable item;

FIG. 8 is a process flow diagram illustrating a method for sharing an item or a container;

FIG. 9 is a process flow diagram illustrating a method for revoking an item or a container; and

FIG. 10 is a process flow diagram illustrating a method for setting an expiration time for an item or a container.

### DETAILED DESCRIPTION OF ILLUSTRATIVE EMBODIMENTS

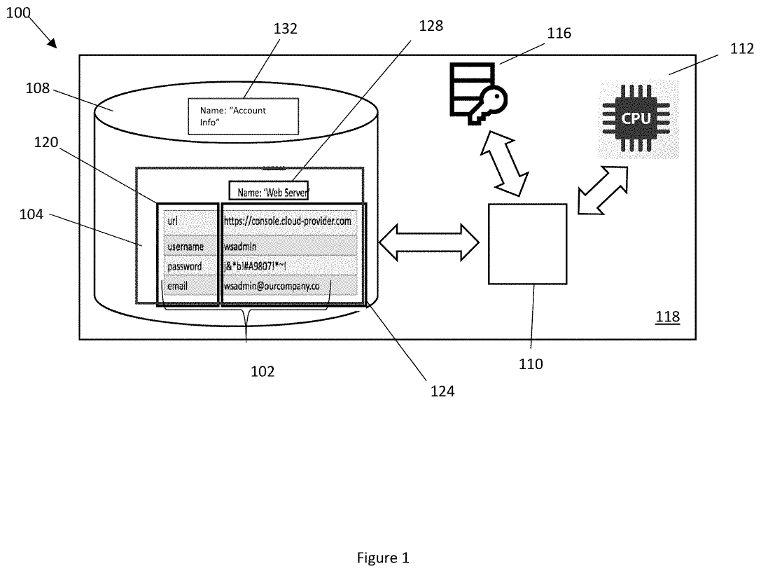

As shown in FIGS. 1-3B, embodiments of the present disclosure include a system 100 configured for digital artifact or information storage and sharing. The system 100 is used to store and share digital artifacts securely without any out-of-band means. These artifacts may be confidential information including passwords, contact information, account information, financial data, or any other information that a user may want to keep both secure and readily accessible when needed. The system 100 creates a secure digital artifact management platform that provides features to control how and when shared artifacts are made available to one or more users. Artifacts may be shared with individual users or with groups of users. The platform allows each user to obtain their own copy of each digital artifact that they create or that is shared with them. The system 100 may additionally revoke a shared artifact by deleting or de-activating the user's copy immediately after revocation is selected or may set an expiration date on a shared artifact.

Referring to FIG. 1, an exemplary system 100 includes at least one item 104, at least one container 108 configured to hold the at least one item 104, a user interface 110, a processor 112, an encryption module 116, and a server 118. The user interface 110 is operatively coupled to and operatively communicates with the item 104, the container 108, the processor 112, the encryption module 116, and the server 118. In the illustrated embodiment, the system 100 includes one item 104 and one container 108. In alternative embodiments, however, the system 100 may include a plurality of containers 108 and a plurality of items 104. Reference to singular or plural items 104 and containers 108 may be used interchangeably hereinafter.

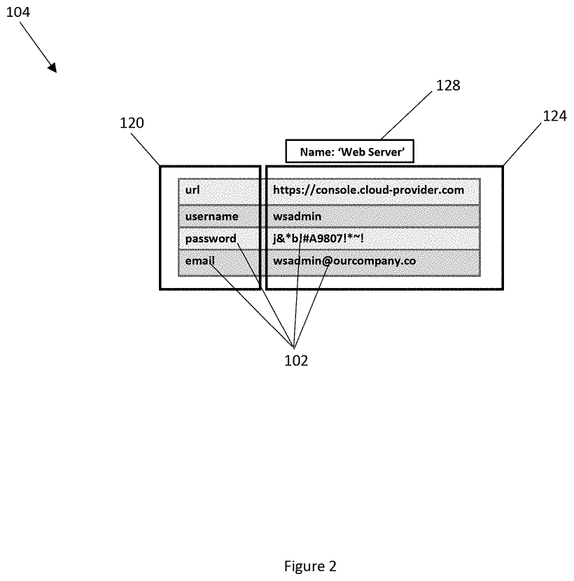

Referring to FIGS. 1 and 2, the item 104 is configured to contain the digital artifact or information 102. The item 104 includes one or more field entry sections 120 and one or more value entry sections 124 corresponding to the one or more field entry sections 120 for a user to input the information 102. Thus, the one or more field entry sections 120 and the one or more value entry sections 124 correspond to the details of the digital artifact or information 102 that the item 104 represents. The item 104 may be a shareable item or a private item. A private item is not shareable with users while a shareable item is shared with designated recipients. In the illustrated embodiment, the recipients are additional users within the system 100. However, in alternative embodiments, the recipients may be individuals outside of the system 100.

In the illustrated embodiment, the information 102 that is input into the item 104 is displayed as textual data. In alternative embodiments, the information 102 may appear as audio data, visual data, or any combination of textual, audio, or visual data. Additionally, in alternative embodiments, the information 102 may be contained in the item 104 utilizing any file type in substitution of or in addition to using the one or more field entry sections 120 and the one or more value entry sections 124. The item 104 may further include an identifier 128 to characterize and distinguish it from other individual items. The item 104 is searchable in the system 100 using the identifier 128.

Referring to FIGS. 1 and 2, the container 108 is configured to contain the at least one item 104. The container 108 includes an identifier 132 to distinguish it from other individual containers. The container 108 is searchable in the system 100 using the identifier 132. In the illustrated embodiment, the item 104 is contained in the container 108. The user may create, edit, modify, delete, and share either or both the item 104 and the container 108. In alternative embodiments, the item 104 may be a standalone item that is not contained in the container 108. The system 100 allows the user to location of the item 104 in either the container 108 or as a standalone item in the system 100. The container 108 may be a shareable container or a private container. A private container is not shareable with users while a shareable container is shared with designated recipients. In the illustrated embodiment, the recipients are additional users within the system 100. However, in alternative embodiments, the recipients may be individuals outside of the system 100.

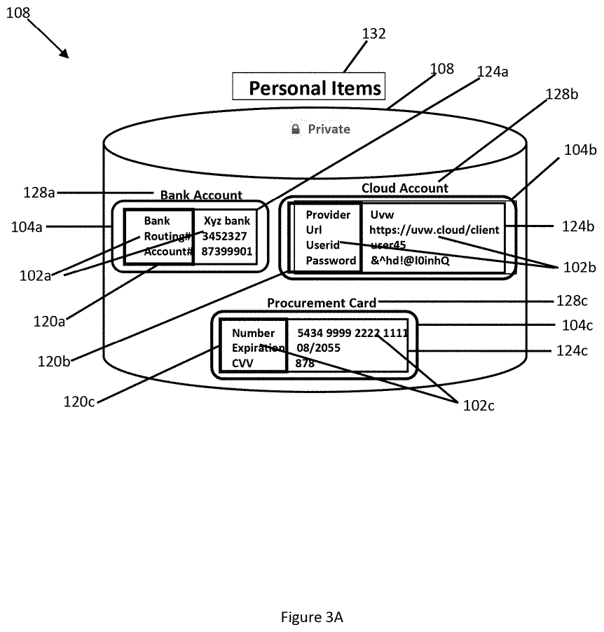

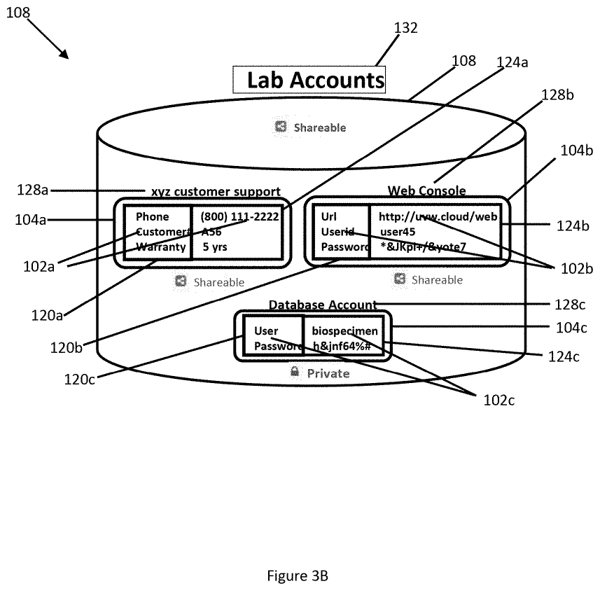

In one example, as shown in FIG. 3A, the container 108 is selected as a private container. The container 108 includes the identifier 132 labeled “Personal Items.” The container 108 is configured to hold a plurality of items 104a, 104b, 104c, each containing information 102a, 102b, 102c, respectively. The information 102a, 102b, and 102c include one or more field entry sections 120a, 120b, 120c, and one or more value entry sections 124a, 124b, 124c. The items 104a, 104b, and 104c include identifiers 128a, 128b, 128c, that are labeled “Bank Account,” “Cloud Account,” and “Procurement Card,” respectively. In the illustrated embodiment, items 104a, 104b, and 104c are designated as private items. Because the container 108 is a private container, the container 108 is configured to hold only private items 104a, 104b, 104c. A shareable item therefore cannot be placed in the container 108 in FIG. 3A.

In another example, as shown in FIG. 3B, the container 108 is selected as a shareable container. The container 108 includes the identifier 132 labeled “Lab Accounts.” The container 108 is configured to hold a plurality of items 104a, 104b, 104c, each containing information 102a, 102b, 102c, respectively. The information 102a, 102b, 102c include one or more field entry sections 120a, 120b, 120c, and one or more value entry sections 124a, 124b, 124c. The items 104a, 104b, and 104c include identifiers 128a, 128b, 128c that are labeled “xyz customer support,” “Web Console,” and “Database Account,” respectively. In the illustrated embodiment, items 104a and 104b are designated as shareable items. Item 104c is designated as a private item. The container 108 is therefore a shareable container configured to hold both shareable items 104a, 104, and private item 104c. When the container 108 is shared with designated third parties, only the shareable items 104a, 104b inside the container 108 are visible to the third parties. Private item 104c contained in the container 108 will be completely hidden from the third party recipients.

Referring to FIG. 1, the encryption module 116 is configured to encrypt the information 102, and the item 104. The encryption module 116 includes a public key cryptosystem and a passphrase in order to secure the information 102 stored in the system 100. The public key cryptosystem consists of a public key which is stored in the server 118 and a private key which is protected by a brute force resistant and memory hardened key derived from a passphrase supplied by the user. The user has an individual public key and private key pair created via the public key cryptosystem. The encryption module 116 operatively communicates with the server 118 and the user interface 110 such that the encryption is performed on the server 118 of the system 100. In an alternative embodiment, the encryption module 116 may allow encryption of the item 104 at a web browser of the recipient. In yet another embodiment, the encryption module 116 may allow encryption of the container 108.

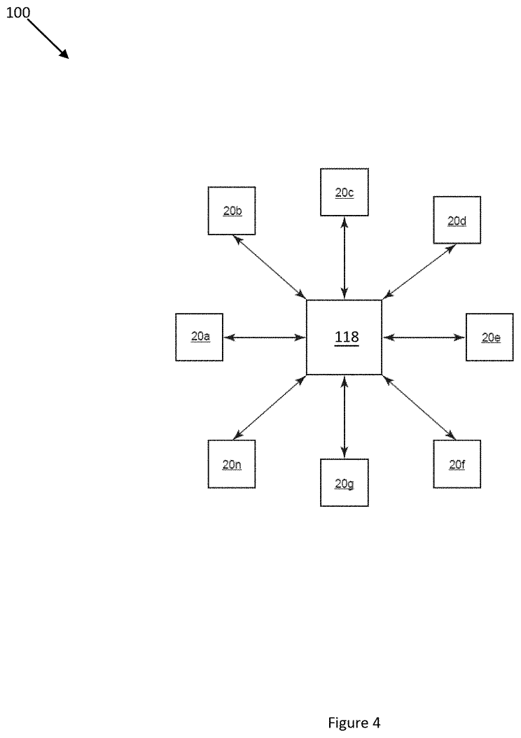

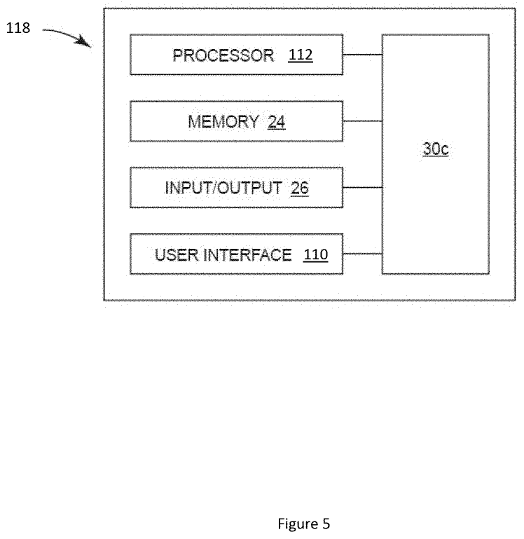

Referring to FIG. 4, an embodiment of the present disclosure is a system 100 including at least one server 118, a plurality of computing devices 20a, 20b, 20c . . . 20n, in electronic communication with the server 118, and one or more software applications 30c (see FIG. 5) implemented across computing devices 20a, 20b, 20c . . . 20n. Each computing device 20a, 20b, 20c . . . 20n may be associated with a different person or user. For purposes of clarifying how the software application is implemented across the various computing devices, reference number 20 is used interchangeably with reference numbers 20a, 20b, 20c . . . 20n, unless noted otherwise. In addition, the present disclosure describes software applications implemented over system components and configured to execute various steps in the methods described below. It should be appreciated that a software application can implement steps in the described methods utilizing all of the system components or just portions of the system components. Furthermore, the software applications are described below in singular form. It should be appreciated that multiple software applications may interface to perform the described functions and multiple applications can run on more than one computing device to implement the methodologies described herein.

Continuing with reference to FIG. 4, the system 100 can be implemented via exemplary architecture that includes computing devices 20a, 20b, 20c . . . 20n in electronic communication with each other via a common communications network, such as, for example, the Internet. As illustrated, the computing devices 20a, 20b, 20c . . . 20n and server 118 are arranged in a client-server architecture. The server 118 can receive and transmit data to other computing devices 20 via the communications network. In addition, one or up to all the computing devices 20 can receive information from the other computing devices 20. And one or up to all of the computing devices 20 can transmit information to the other computing devices 20. Furthermore, one or all of the computing devices 20 can access information on the other computing devices 20. “Access” or “accessing” as used herein can include retrieving information stored in memory on a computing device. For instance, “access” or “accessing” includes sending instructions via the network from server 118 to computing device 20a so as to cause information to be transmitted to the memory of the computing device 20a for access locally by the computing device 20a. In addition, or alternatively, “access” or “accessing” can include the server 118 sending an instruction to computing device 20a to access information stored in the memory of the computing device 20a. Reference to server 118 and computing device 20a in this paragraph is exemplary and are used to only clarify use of words “access” or “accessing.”

FIG. 4 illustrates a client-server network. But the software application can be implemented over any number of network configurations. For example, in alternate embodiments, the computing devices 20a, 20b, 20c . . . 20n are configured as a peer-to-peer network architecture. In still other alternative embodiments, the computing devices 20a, 20b, 20c . . . 20n can be arranged in a ring-type network architecture. Further, the software application can be implemented across computing devices arranged on a network that includes aspects of a client-server network, peer-to-peer network, ring-type network, and/or other network architectures known to a person of ordinary skill in the art. Accordingly, it should be appreciated that numerous suitable alternative communication architectures are envisioned for implementing a software application 30c (FIG. 5) on a user's computing device.

Turning to FIG. 5, the computing device 20 is configured to receive, process, and store various information used to implement one or more software applications, such as client software application 30c. It will be understood that the hardware components of computing device 20 can include any appropriate device, examples of which include a portable computing device, such as a laptop, tablet or smart phone, or other computing devices, such as, a desktop computing device or a server-computing device.

As illustrated in FIG. 5, the server 118 includes one or more processors 112, a memory 24, an input/output 26, and a user interface (UI) 110. It is emphasized that the operation diagram depiction of the server 118 is exemplary and not intended to imply a specific implementation and/or configuration. The processor 22, memory 24, input/output portion 26 and user interface 110 can be coupled together to allow communications therebetween and can interface with the client software application 30c. The client software application 30c may include an application programmatic interface (API). As should be appreciated, any of the above components may be distributed across one or more separate devices.

Continuing with FIG. 5, the memory 24 can be volatile (such as some types of RAM), non-volatile (such as ROM, flash memory, etc.), or a combination thereof, depending upon the exact configuration and type of processor 112. The server 118 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic storage or other magnetic storage devices, universal serial bus (USB) compatible memory, or any other medium which can be used to store information and which can be accessed by the server 118.

Continuing with FIG. 5, in various embodiments, the input/output portion 26 includes an antenna or an electronic connector for wired connection, or a combination thereof. In some implementations, input/output portion 26 can include a receiver and transmitter, transceiver or transmitter-receiver. The input/output portion 26 is capable of receiving and/or providing information pertaining to communication with a network such as, for example, the Internet. As should be appreciated, transmit and receive functionality may also be provided by one or more devices external to the server 118. For instance, the input/output portion 26 can be in electronic communication with a receiver.

Referring to FIG. 5, the user interface 110 can include an input device and/or display (input device and display not shown) that allows a user to communicate with the server 118 and the computing device 20. The user interface 110 can include inputs that provide the ability to control the computing device 20, via, for example, buttons, soft keys, a mouse, voice actuated controls, a touch screen, movement of the computing device 20, visual cues (e.g., moving a hand in front of a camera on the computing device 20), or the like. The user interface 110 can provide outputs, including visual displays. Other outputs can include audio information (e.g., via speaker), mechanically (e.g., via a vibrating mechanism), or a combination thereof. In various configurations, the user interface 110 can include a display, a touch screen, a keyboard, a mouse, an accelerometer, a motion detector, a speaker, a microphone, a camera, or any combination thereof. It should be appreciated that the computer devices can operate via any suitable operating system, such as Android, BSD, iOS, Linux, OS X, QNX, Microsoft Windows, Windows Phone, and IBM z/OS. Furthermore, the software application 30c can operate with any of the aforementioned operation systems.

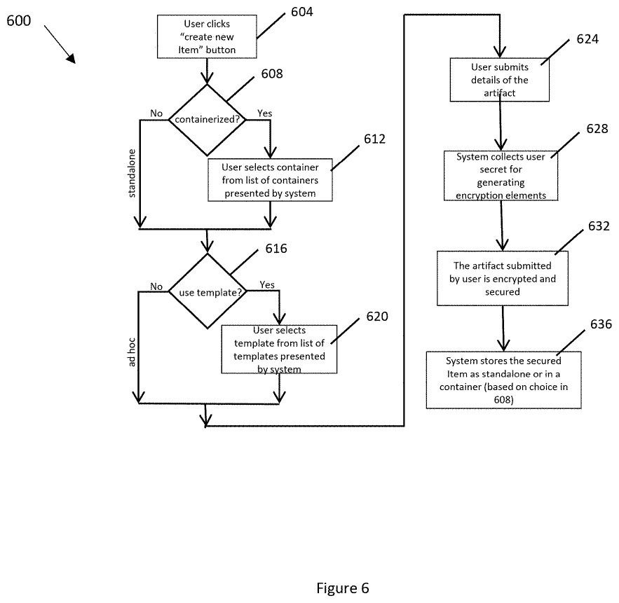

Now referring to FIG. 6, a method 600 for creating an item 104 utilizing the system 100 shown in FIGS. 1-3 will be described. In step 604, the user requests to create a new item 104 in the system 100 by selecting an input in the system 100 via the user interface 110. In step 608, the user inputs into the system 100 whether to hold the item 104 in a container 108 or create the item 104 as a standalone item. In step 612, if the user inputs to hold the item 104 in a container 108, then the system 100 processes the request and provides a list of created containers for selection by the user.

In step 616, the user determines whether to use a template to create the item 104. The one or more field entry sections 120 may be arranged into a template for the user to input the information 102 into the item 104. In a template, the one or more field entry sections 120 of the item 104 are predefined. The template may therefore be used as a guide to create the at least one item 104 in the container 108. When using a template to create the item 104, the user inputs information into the one or more value entry sections 124 corresponding to the predefined one or more field entry sections 120. The system 100 may provide a set of templates for the user to create or modify. For example, the system 100 may provide a template including the one or more field entry sections 120 and the one or more value entry sections 124 arranged into a note for the user to input information 102 into the item 104. In a note, two predefined field entry sections 120 and two value entry sections 124 are used to input the information 102. The predefined fields include the identifier 128 and a field entry comprising data content for inputting textual information. In step 620, if the user determines to use a template, then the system 100 processes the request and provides a list of templates for selection by the user.

In step 624, the user inputs data regarding the information 102 into the one or more field entry sections 120 and the one or more value entry sections 124 of the item 104 via the user interface 110. In step 628, the system 100 collects the user's passphrase for generating encryption elements. In step 632, the encryption module 116 encrypts the information 102. In step 636, the system 100 stores the secured item 104 as a standalone item or in a container 108 based on the user input in step 608.

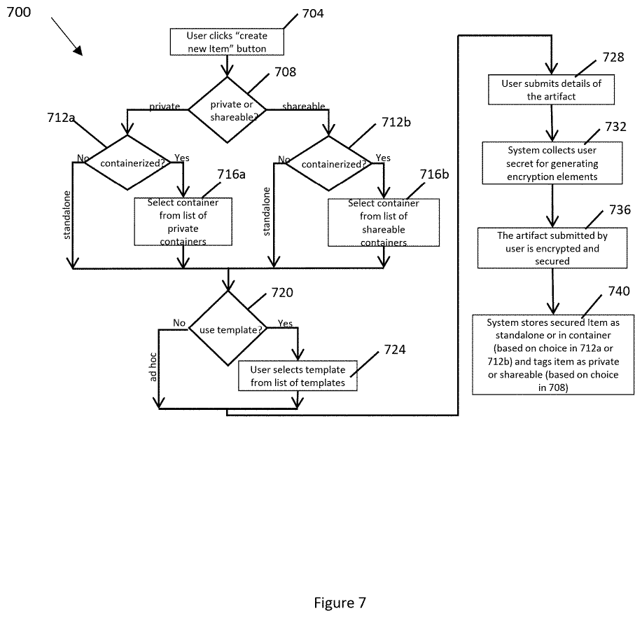

Now referring to FIG. 7, a method 700 for creating a private or shareable item 104 utilizing the system 100 shown in FIGS. 1-3 will be described. In step 704, the user requests to create a new item 104 in the system 100 by selecting an input in the system 100 via the user interface 110. In step 708, the user determines whether the item 104 will be designated as a private item or a shareable item.

In the illustrated embodiment, the system 100 allows the user to select whether the item 104 is a shareable item or a private item via the user interface 110. A private item is not shareable with users while a shareable item is shared with designated recipients. The system 100 allows the owner of the item 104 to share the item 104 with one or more designated recipients. In the illustrated embodiment, the recipients are additional users within the system 100. However, in alternative embodiments, the recipients may be individuals outside of the system 100. When the item 104 is shared, the recipient is granted permission to view the item 104. The system 100 allows the owner to grant an additional “update” permission and an “ownership” permission. When the recipient is granted the “update” permission, the system 100 allows the recipient to edit the item 104. When the recipient is granted the “ownership” permission, the system 100 allows the recipient to take ownership of the item 104.

In step 712a, if the user selects a private item, then the user determines whether to hold the private item in a container 108 or create the private item as a standalone item. In step 716a, if the user determines to hold the private item 104 in a container 108, then the system 100 processes the request and provides a list of created containers for selection by the user. In step 712b, if the user selects a shareable item, then the user determines whether to hold the shareable item in a container 108 or create the shareable item as a standalone item. In step 716b, if the user determines hold the shareable item 104 in a container 108, then the system 100 processes the request and provides a list of created containers for selection by the user.

In step 720, the user determines whether to use a template to create the private or shareable item 104. In step 724, if the user determines to use a template, then the system 100 processes the request and provides a list of templates for selection by the user. In step 728, the user inputs data regarding the information 102 into the one or more field entry sections 120 and the one or more value entry sections 124 of the private or shareable item 104 via the user interface 110. In step 732, the system 100 collects the user's passphrase for generating encryption elements. In step 736, the private or shareable item 104 is encrypted and secured by the encryption module 116. In step 740, the system 100 stores the secured private or shareable item 104 as a standalone item or in a container 108 based on the user input in step 712a or 712b.

In the illustrated embodiments, the system 100 may further allow the user to select whether the container 108 is a shareable container or a private container via the user interface 110. A private container is not shareable with users, while a shareable container is shared with designated recipients. The system 100 allows the owner of the container 108 to share the container 108 with one or more designated recipients. In the illustrated embodiment, the recipients are additional users within the system 100. However, in alternative embodiments, the recipients may be individuals outside of the system 100. When the container 108 is shared, the recipient is granted permission to view the container 108. The system 100 allows the owner of the container to grant an additional “update” permission and an “ownership” permission. When the recipient is granted the “update” permission, the system 100 allows the recipient to edit the container 108. Editing allows the recipient to edit existing shared items in the container 108 or add new shared items to the container 108. When the recipient is granted the “ownership” permission, the system 100 allows the recipient to take ownership of the container 108.

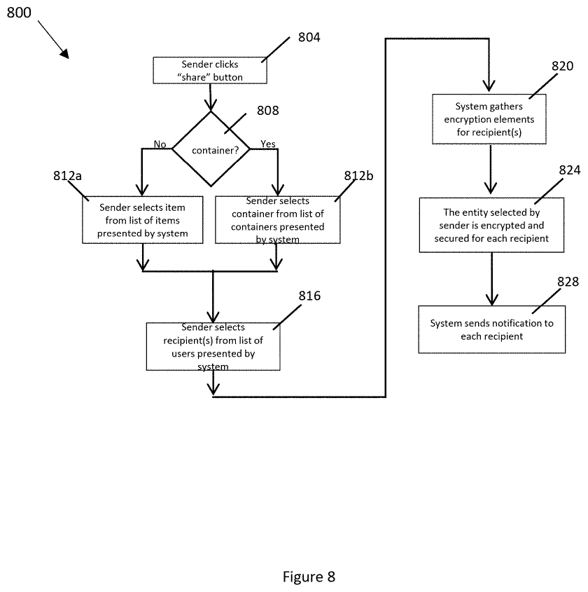

Now referring to FIG. 8, a method 800 for sharing an item 104 or a container 108 utilizing the system 100 shown in FIGS. 1-3 will be described. In step 804, the user requests to share an item 104 or a container 108 in the system 100 by selecting an input in the system 100 via the user interface 110. In step 808, the user selects whether it desires to share an individual item 104 or a container 108 containing one or more items. In step 812a, if the user selects to share an item 104, then the system 100 processes the request and provides a list of created items for selection by the user. In step 812b, if the user selects to share a container 108, then the system 100 processes the request and provides a list of created containers for selection by the user. In step 816, the user selects third party recipients to share the item or container with from a list of recipients provided by the system 100. In step 820, the system 100 gathers encryption elements for the recipients.

In step 824, the item selected by the user is encrypted and secured for each recipient via the encryption module 116. When the item 104 is stored in the system 100, the contents of the item 104 are first encrypted using the user's public key from the public key cryptosystem. When the item 104 is retrieved, it is decrypted using the private key from the public key cryptosystem. The public key cryptosystem is personalized using the passphrase that is chosen by the user. The system 100 generates the key pair (private & public) for the user using the user's passphrase. In order to retrieve an item 104 stored in the system 100, the user provides the passphrase. When the item 104 is shared, each designated third party recipient of the shareable item 104 gets a copy of the item. The copy is encrypted with the recipient's public key. The item 104 encrypted with a public key is decryptable with the paired private key using the passphrase supplied by the user.

The location of where the encryption is performed may be either on the server 118 of the system 100 or at a web browser of the recipient. Encryption performed at the web browser of the recipient has the advantage of not having information in a temporarily decrypted state on the server 118 (as copies are being made for each recipient). In this case, the user holds their private key locally and it is never stored on the server 118, allowing for decryption to be solely done at the web browser of the recipient. In step 828, the system sends a notification to each recipient with a pointer to an encrypted copy of the item.

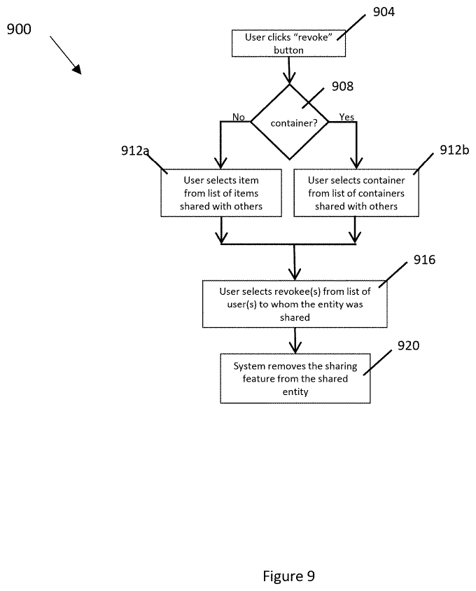

Now referring to FIG. 9, a method 900 for revoking an item 104 or a container 108 from being shared with a recipient, utilizing the system 100 shown in FIGS. 1-3, will be described. The system 100 allows the user to revoke the item 104 or the container 108 selected as a shareable item or container to one or more designated recipients who the item 104 or the container 108 has been shared to. In step 904, the user requests to revoke a shared item 104 or a container 108 in the system 100 by selecting an input in the system 100 via the user interface 110. In step 908, the user selects whether it desires to revoke an item 104 or a container 108. In step 912a, if the user selects to revoke an item 104, then the system 100 processes the request and provides a list of created and shared items for selection by the user. In step 912b, if the user selects to revoke a container 108, then the system 100 processes the request and provides a list of created and shared containers for selection by the user. The user may designate the recipients to revoke sharing the item 104 or the container 108. In step 916, the user selects the designated recipients to revoke the item 104 or the container 108 from a list of recipients provided by the system 100 in which the item 104 or the container 108 was shared. In step 920, the system 100 revokes the item 104 or the container 108 from the selected recipients. When the sharing is revoked, the recipient is no longer able to access the shared item 104 or container 108.

In addition, the system 100 allows the user to set an expiration time on the item 104 or container 108 selected as a shareable item or container. The user can specify the time period after which the item 104 or container 108 will expire. Once expired, the item 104 and the information 102 contained in the item 104 or container 108 is unavailable to any recipients to whom the item 104 or container 108 was shared.

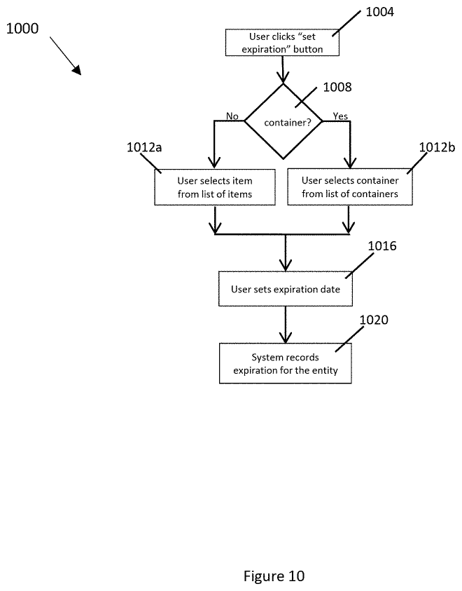

Now referring to FIG. 10, a method 1000 for setting an expiration time for an item 104 or a container 108, utilizing the system 100 shown in FIGS. 1-3, will be described. In step 1004, the user requests to set an expiration time for an item 104 or a container 108 in the system 100 by selecting an input in the system 100 via the user interface 110. In step 1008, the user selects whether it desires to set an expiration time for an item 104 or a container 108. In step 812a, if the user selects to set an expiration time for an item 104, then the system 100 processes the request and provides a list of created and shared items for selection by the user. In step 1012b, if the user selects to set an expiration time for a container 108, then the system 100 processes the request and provides a list of created and shared containers for selection by the user. In step 1016, the user sets the expiration time for the item 104 or the container 108. In step 1020, the system 100 records the expiration time for the item or container.

The user interface 110 of the system 100 is configured to allow single sign-on to a corporate directory service. The system 100 may utilize Active Directory or Lightweight Directory Access Protocol for single sign-on use, allowing the user to log in to the system 100 using corporate username and password. The system 100 is further configured to include the Simple Mail Transfer Protocol (SMTP) configuration to enable email communication to the one or more user accounts.

The system 100 is further configured to create and maintain one or more administrator accounts and one or more user accounts. The one or more administrator accounts are configured to manage the one or more users via the respective user accounts in the system 100. In addition, the one or more user accounts are configured to allow digital artifacts or information 102 to be stored in the system 100.

The present disclosure is described herein using a limited number of embodiments, these specific embodiments are not intended to limit the scope of the disclosure as otherwise described and claimed herein. Modification and variations from the described embodiments exist. More specifically, the following examples are given as a specific illustration of embodiments of the claimed disclosure. It should be understood that the invention is not limited to the specific details set forth in the examples.

The phraseology and terminology used herein is for the purpose of description and should not be regarded as limiting. The use of “including”, “comprising”, or “having”, “containing”, “involving”, and variations thereof herein, is meant to encompass the items listed thereafter and equivalents thereof as well as additional items.

1. A secure digital storage system for a plurality of users the digital storage system comprising:
at least one computing device having a processor and memory;
at least one container stored in the memory, the at least one container configured to be selectively switchable between a private status and a shareable status;
at least one item stored in the memory, the at least one item including information, the at least one item located in the container and configured to be selectively switchable between a private status and a shareable status, wherein the shareable status of the at least one item and the at least one container are selectively revocable;
an encryption module stored in the memory and executable by the processor, the encryption module configured to encrypt the at least one item; and
a software application, configured to, when executed by the processor:
encrypt the at least one item;
determine whether each one of the at least one item and the at least one container is private or shareable;
if the at least one item is private and the at least one container is shareable, hide the item and share the container containing the hidden item with one or more users;
if the at least one item and the at least one container is shareable, share the item or share the item and the container with one or more users; and
selectively revoke shareability of the item or shareability of the item and the container.

2. The digital storage system of claim 1 further comprising an additional item located in the at least one container.

3. The digital storage system of claim 1, further comprising a user interface having one or more field entry sections; and
one or more value entry sections corresponding to the one or more field entry sections, the one or more field entry sections and the one or more value entry sections configured to allow input of information into the item.

4. The digital storage system of claim 3, wherein the one or more field entry sections are predefined.

5. The digital storage system of claim 3, wherein the user interface is configured to display the information as one or a combination of textual data, visual data, and audio data.

6. The digital storage system of claim 3, wherein the shareable status is configured to allow the at least one item and the at least one container to be shared with and accessed by one or more recipients via the user interface.

7. The digital storage system of claim 6, wherein the shareable status is further configured to allow the one or more recipients to modify the at least one item and the at least one container via a user interface.

8. The digital storage system of claim 6, wherein the shareable status is further configured to allow the one or more recipients to take ownership of the at least one item and the at least one container via a user interface.

9. The digital storage system of claim 6, wherein revocation of the shareable status of the at least one container and the at least one item revokes access to the at least one container and the at least one item by the one or more recipients.

10. The digital storage system of claim 3, further comprising a server, the processor and the server operatively coupled to the user interface.

11. The digital storage system of claim 1, wherein the information is input as any file type.

12. The digital storage system of claim 1, wherein the private status is configured to prevent the at least one item and the at least one container from being shared with and accessed by one or more users.

13. The digital storage system of claim 1, wherein the shareable status expires after a selected period of time.

14. The digital storage system of claim 1, wherein the encryption module comprises:
a public key configured to encrypt the at least one item and the at least one container;
a private key configured to decrypt the at least one item; and
a shareable passphrase configured to decrypt the private key.

15. The digital storage system of claim 1, wherein the at least one item and the at least one container are further configured to be created, modified, and deleted.

16. The digital storage system of claim 1, wherein the at least one item and the at least one container include at least one identifier configured to characterize the at least one item and the at least one container.

17. The digital storage system of claim 1, further comprising at least one standalone item configured to be held in the system outside of the at least one container.

18. A method for securely sharing information, comprising:
inputting with a user interface information into an item stored in computer memory of a computing device, wherein an item is held in a container;
encrypting the item;
determining whether each one of the item and the container is private or shareable;
if the item is private and the container is shareable, hiding the item and sharing the container containing the hidden item with one or more users;
if the item and the container is shareable, sharing the item or sharing the item and the container with one or more users; and
selectively revoking shareability of the item or shareability of the item and the container.

19. The method of claim 18, wherein the inputting step further comprises entering the information in one or more field entry sections and one or more value entry sections corresponding to the one or more field entry sections.

20. The method of claim 18, wherein the determining step further comprises preventing the item and the container from being shared with and accessed by the one or more users if the item and the container are determined to be private.

21. The method of claim 18, wherein the sharing step further comprises granting access to the item and the container.

22. The method of claim 21, further comprising allowing the one or more users to modify the item and the at least one container.

23. The method of claim 21, further comprising allowing the one or more users to take ownership of the item and the container.

24. The method of claim 18, wherein the sharing step further comprises setting the shareability of the item and the container to expire after a selected time period.

25. The method of claim 18, wherein the revoking step further comprises immediately revoking access to the container and the item by the one or more users.

26. The method of claim 18, wherein the encrypting step further comprises using a) a public key to encrypt the item, b) a private key to decrypt the item when the item and the container are shared with the one or more users, and c) a private passphrase to decrypt the private key.

27. The method of claim 18, further comprising modifying and deleting the item.

28. The method of claim 18, further comprising creating, modifying, and deleting the container.

29. The method of claim 18, further comprising creating at least one standalone item configured to be held outside of the container.
